(19) United States
(12) Patent Application Publication
(10) Pub. No.: US 2023/0125905 A1
(43) Pub. Date: Apr. 27, 2023

(54) CATHODE ACTIVE MATERIAL FOR LITHIUM SECONDARY BATTERY

(71) Applicant: L&F CO., LTD., Daegu (KR)

(72) Inventors: Jae Shin SHIN, Daegu (KR); Sung Kyun CHANG, Daegu (KR); Chang Min CHOI, Daegu (KR); Joo Hyeong WOO, Daegu (KR); Jae Joon JO, Daegu (KR)

(21) Appl. No.: 18/007,506

(22) PCT Filed: Jun. 1, 2021
(86) PCT No.: PCT/KR2021/006780

§ 371 Date: Dec. 1, 2022

(30) Foreign Application Priority Data
Jul. 16, 2020 (KR) 10-2020-0087922

(51) Int. Cl. H01M 4/62; H01M 4/485; H01M 4/04; H01M 10/052

(52) U.S. Cl. CPC H01M 4/62; H01M 4/485; H01M 4/0471; H01M 10/052; H01M 2004/028

(57) ABSTRACT

Disclosed is a cathode active material for a lithium secondary battery including a core containing lithium composite metal oxide, and a coating layer disposed on the core and including an amorphous phase, wherein the amorphous phase contains lithium oxide and boron oxide in a form of mixture.

### TECHNICAL FIELD

The present invention relates to a cathode active material for a lithium secondary battery including a core containing lithium composite metal oxide, and a coating layer disposed on the core, wherein the coating layer includes an amorphous phase containing lithium oxide and boron oxide in a form of mixture.

### BACKGROUND ART

Lithium secondary batteries are used in various fields such as mobile devices, energy storage systems, and electric vehicles due to advantages such as high energy density and voltage, low self-discharge rate, and semi-permanence to provide repeated use based on chargeability and discharge ability.

However, as lithium secondary batteries are repeatedly charged and discharged due to the use of devices or apparatuses to which they are applied, and intercalation and deintercalation of lithium ions are repeated, structural instability increases, thus disadvantageously causing changes in the structure of oxide and deterioration in lifespan characteristics. Such a phenomenon may be particularly serious when lithium secondary batteries are driven at a high temperature.

Accordingly, there are various examples of coating the surface of a cathode active material with metal oxide in order to solve these problems.

However, in general, the coating layer formed on the surface of the active material is formed in a crystallized state, and as a result, the crystallized coating layer may not be properly coated on the core surface or a uniform surface coating may not be achieved. Such a coating layer may not properly perform its own role as the lithium secondary battery is used for a long time.

In addition, in order to select a coating material constituting the coating layer, the desired effect of the coating layer, the optimum heat treatment temperature, economic feasibility of the process, and the like should be comprehensively considered.

Therefore, there is an increasing demand for development of cathode active materials that are determined under comprehensive consideration of selection of the coating material based on the optimum heat treatment temperature and reduction of the process cost, and exhibit the desired levels of characteristics through the introduction of the coating layer by solving the problems caused by the crystallization of the coating layer when designing the coating layer of conventional cathode active materials.

### DISCLOSURE

### Technical Problem

Therefore, the present invention has been made to solve the above and other technical problems that have yet to be solved.

After repeated extensive research and various experiments, the present inventors have developed a novel cathode active material including a coating layer having an amorphous phase that can exhibit optimal performance at a relatively low cost and have found that, since the coating layer of the cathode active material includes an amorphous phase containing lithium oxide and boron oxide in a form of mixture, the coating layer is coated uniformly while preventing deterioration of the binding affinity to the core, and improves the cycle and capacity characteristics of lithium secondary batteries, and in particular, high temperature characteristics thereof, thus completing the present invention.

### Technical Solution

In accordance with an aspect of the present invention, provided is a cathode active material for a lithium secondary battery including a core containing a lithium composite metal oxide, and a coating layer disposed on the core, wherein the coating layer includes an amorphous phase containing lithium oxide and boron oxide in a form of mixture.

The present applicant has suggested boron (B), tungsten (W), or the like as components that may be included in the coating layer in the related art in the cathode active material to improve low-temperature characteristics. However, since low-temperature characteristics and high-temperature characteristics are based on completely different mechanisms of action, it is difficult to determine that these components contribute to high-temperature characteristics as well as low-temperature characteristics.

In addition, it is confirmed that for boron (B), about 250 to about 350° C. is an optimized heat treatment temperature to form a coating layer and for tungsten (W), about 400 to about 450° C. is an optimized heat treatment temperature to form a coating layer. That is, optimal heat treatment conditions for boron (B) and tungsten (W) also do not overlap.

Moreover, tungsten is a relatively expensive component compared to general components constituting the coating material, and as described above, has a relatively high heat treatment temperature, thus causing an increase in process cost, which is undesirable.

Based on the facts described above, the inventors of the present application have found that, when forming the coating layer of the amorphous phase with a combination of boron oxide and lithium oxide in a state excluding tungsten oxide, boron having a relatively low heat treatment temperature acts more effectively to reduce crystallization of the coating layer and improves the cycle and capacity characteristics of the lithium secondary battery, and especially the high temperature characteristics thereof, while forming a uniform coating on the surface of the core under conditions that can exhibit optimal performance at a low cost.

In one specific embodiment, the lithium composite metal oxide may include one or more transition metals and may have a layered crystal structure usable at high capacity and high voltage, and specifically, may be a material represented by the following Formula 1.

Li[LiₓM_{1-x-y}D_{y}]O₂₋ₐQₐ (1)
wherein M includes at least one transition metal element stable in tetra- or hexacoordinate, D includes, as a dopant, at least one element selected from alkaline earth metals, transition metals, and nonmetals, Q includes at least one anion, and x, y, and a satisfy 0≤x≤0.1, 0≤y≤0.1, and 0≤a≤0.2, respectively.

For reference, provided that D is a transition metal, the transition metal defined for M is excluded from the transition metal for D.

In one preferred embodiment, M may include at least two elements selected from the group consisting of Ni, Co, and Mn, D may include at least one element selected from the group consisting of Al, W, Si, V, B, Ba, Ca, Zr, Ti, Mg, Ta, Nb, and Mo, and Q may include at least one element selected from F, S, and P.

In addition, the lithium composite metal oxide may have a crystal structure rather than a layered structure, and examples of such a crystal structure include, but are not limited to, a spinel structure and an olivine structure.

The core may have an average particle diameter (D50) of, for example, 1 to 50 μm, but is not particularly limited.

The lithium composite metal oxide forming the core of the composition may be prepared by a method known in the art and thus a description thereof will be omitted herein.

One of the features of the present invention is that the coating layer has an amorphous phase including lithium oxide and boron oxide in a form of mixture.

For this reason, as can be seen from the experimental results later, in X-ray diffractometry, no peak is observed in the vicinity of any one of 2θ=32.05°, 26.003°, 28.051°, 14.971°, 33.646°, and 56.407°.

As will be described later, lithium oxide and boron oxide included in the amorphous phase may be attached to the surface of the core at a low firing temperature to perform surface treatment of the core which includes a lithium composite metal oxide. In this process, the lithium oxide can act as a coating agent to facilitate the adhesion of boron oxide to the core.

In one specific embodiment, the coating layer may include a composition of the following Formula 2:

αBₓO_{y}−βLi₂O (2)

wherein the conditions of α+β=1 and 0.35≤x/y≤0.75 are satisfied, and α and β are determined on a weight basis.

As a non-limiting example, the material of Formula 2 may be represented by αB₂O₃−βLi₂O.

As a specific example of lithium oxide, Li₂O may improve the meltability or moldability of the coating layer by lowering the high-temperature viscosity of the glassy oxide. In addition, Li₂O has excellent lithium ion conductivity and does not react with an electrolyte solution and hydrogen fluoride derived from electrolyte solution during charging/discharging. Such Li₂O may be formed by oxidization by firing of the lithium compound added before firing, or may be added as Li₂O itself. Also, Li₂O may be derived from a lithium-containing component such as LiOH, Li₂CO₃, or the like present on the surface of the lithium composite metal oxide as the core.

The lithium oxide is present in the amorphous phase in an amount of 2 parts by weight or less, preferably 0.01 to 2 parts by weight, more preferably 0.05 to 1 parts by weight, particularly preferably 0.05 to 0.5 parts by weight based on 100 parts by weight of the lithium composite metal oxide as the core.

When the content of lithium oxide is excessively low, there is a problem in that it is difficult to achieve a uniform coating as described above. On the other hand, when the content of lithium oxide is excessively high, the coating thickness increases, thus causing a problem in that the coating layer acts as a resistance in the battery, which is not preferable.

In one specific embodiment, the boron oxide may be B₂O₃ and/or B₂O₅, preferably B₂O₃.

The boron oxide may exist as an ion conductor and may easily form an amorphous phase, thereby improving coating formability together with lithium oxide.

The boron oxide is present in the amorphous phase in an amount of 2 parts by weight or less, preferably 0.01 to 2 parts by weight, more preferably 0.01 to 1 parts by weight, particularly preferably 0.01 to 0.5 parts by weight based on 100 parts by weight of the lithium composite metal oxide as the core.

When the content of boron oxide is excessively low, it may be difficult to achieve the effect as described above, and when the content of boron oxide is excessively high, it acts as a resistor on the surface, thus causing a problem of capacity reduction, which is not preferable.

In one preferred embodiment, the coating layer may include only the lithium oxide and the boron oxide.

As can be seen from the experimental details given later, since the amorphous coating layer constituting the secondary battery capable of exhibiting excellent operating performance can be formed in the temperature range of the optimum heat treatment condition of boron oxide, a coating layer exhibiting desired properties can be formed at a low cost without adding a component or compound having a heat treatment temperature condition different from the temperature range of the optimum heat treatment condition of boron oxide.

Accordingly, the specific combination of lithium oxide and boron oxide in the coating layer acts to improve cycle characteristics, capacity characteristics in particular, high temperature characteristics, and the like of the secondary battery based on excellent coatability and reduction of residual lithium by-products through the interaction of the respective oxides.

In one specific embodiment, the thickness of the coating layer may be 0.01 to 1 μm, preferably 0.01 to 0.5 μm. When the thickness of the coating layer is excessively small, it is difficult to achieve improvement of the desired properties in the present invention, and on the other hand, when the thickness of the coating layer is excessively great, it may act as an obstacle that hinders the movement of lithium to increase the resistance in the battery, which is not preferable.

In addition, the coating layer is preferably distributed in 40% or more, more preferably 90% or more, particularly preferably 100%, based on the surface area of the core, in order to improve the desired performance of the lithium secondary battery in the present invention.

The present invention also provides a method for preparing the cathode active material. Specifically, the method according to the present invention includes mixing a lithium composite metal oxide powder for a core with a boron-containing powder, or a boron-containing powder and a lithium-containing powder as a raw material for coating and firing the mixture under an atmosphere containing oxygen in the temperature range at which the amorphous coating layer is formed.

That is, according to an embodiment of the preparation method of the present invention, core and coating materials for preparing a cathode active material are mixed in the form of powders, rather than a solvent-based mixture such as a slurry, suspension, or solution, followed by firing. As a result, it is possible to prevent a phenomenon in which a crystalline phase is formed by reaction between the coating raw materials and to achieve effects of improving preparation process workability and reducing preparation costs because solvents are not used.

The boron-containing powder may be the boron oxide (e.g., B₂O₃) that is itself to be contained in the coating layer, or may in some cases be other boron compounds capable of being converted into boron oxides through oxidation. Examples of such other boron compounds include, but are not limited to, H₃BO₃ and HBPO₄.

The lithium-containing powder may be the lithium oxide that is itself to be contained in the coating layer, or may be other lithium compounds capable of being converted into lithium oxides through oxidation in some cases. Examples of such lithium compounds include, but are not limited to, LiOH, Li₂CO₃, LiNO₃, Li₂SO₄ and the like.

Here, the lithium oxide of the amorphous coating layer may be derived from a lithium-containing component present on the surface of the lithium composite metal oxide powder. In some cases, the method may include mixing only a boron-containing powder with a lithium composite metal oxide powder, followed by firing.

The temperature range, within which the amorphous coating layer is formed, may vary slightly depending on the type and content requirements of the raw materials, and may be determined within a range within which the coating raw material does not form a crystal structure and does not diffuse into the core, for example, 450° C. or less, preferably from 170° C. to 450° C., and more preferably from 250° C. to 350° C. at which the excellent effect thereof was also demonstrated in the related experiments later. When the firing temperature is excessively low, adhesion of the oxide to the surface of the core may be deteriorated. Conversely, when the firing temperature is excessively high, undesirably, the coating layer is crystallized and it may be difficult to form a uniform coating layer on the surface of the core.

The firing time may be within the range of about 2 to about 20 hours.

The coating raw material such as boron-containing powder preferably has an average particle diameter of about 0.01 to about 5 μm, so that the particles can be uniformly adsorbed on the surface of the core without causing agglomeration therebetween when mixing the core with the coating raw material for the preparation of the cathode active material. The particles are partially or completely melted during the firing process and are transformed into an amorphous phase to form a coating layer having the thickness defined above.

When firing is performed under the conditions described above, a coating layer having an amorphous phase containing lithium oxide and boron oxide in a form of mixture is formed, such that the coating area and uniformity can be increased and thus scalability can be increased when coating the surface of a core.

Therefore, in the present invention, since the coating layer is uniformly coated on the surface of the active material due to excellent moldability, a phenomenon in which the coating material is separated from the active material and exists separately or aggregation can be suppressed, the amount of residual lithium on the surface of the active material is reduced, and the surface coverage effect is obtained, as a result, capacity characteristics and high rate characteristics of the lithium secondary battery can be increased, and in particular, cycle characteristics and resistance characteristics at high temperatures can be improved.

The present invention also provides a lithium secondary battery including the cathode active material. The configuration and production method of the lithium secondary battery are known in the art, and thus a detailed description thereof will be omitted herein.

### Effects of the Invention

As described above, the cathode active material according to the present invention includes a coating layer having an amorphous phase on the surface of the core and thus can be produced under conditions that can exhibit optimal performance at a relatively low cost. Also, the coating layer is coated on the core uniformly and over a large area while reducing the amount of lithium by-products remaining on the surface of the core, thereby improving the cycle and capacity characteristics of the lithium secondary battery, and in particular improving high-temperature characteristics.

### BRIEF DESCRIPTION OF DRAWINGS

FIG. 1 is an X-ray diffraction graph of cathode active materials of Examples 1, 2, and 3 and Comparative Example 1; and

FIGS. 2A and 2B illustrate the results of FE-SEM for comparative surface analysis of cathode active materials of Example 1 and Comparative Example 1.

### BEST MODE

Now, the present invention will be described in more detail with reference to the following examples. These examples should not be construed as limiting the scope of the present invention.

### Example 11

### (Preparation of Cathode Active Material)

H₃BO₃ was mixed in the amount shown in Table 1 below using a dry mixer with 100 parts by weight of lithium composite metal oxide (Li(Ni_{0.82}Co_{0.11}Mn_{0.07})_{0.994}Ti_{0.004}Zr_{0.002}O₂) which was washed with distilled water and dried in an oven, followed by heat treatment in an O₂ atmosphere at 300° C. for 12 hours, to prepare a cathode active material having a coating layer having an amorphous phase containing lithium oxide and boron oxide.

It was ascertained that lithium oxide (Li₂O) was produced by oxidation of the byproduct remaining on the surface of the lithium composite metal oxide and the content of the lithium compound remaining on the surface of the lithium composite metal oxide prior to the heat treatment was about 0.3 to 0.6 parts by weight when measured using acid/base neutralization titration, and about 0.1 to 0.25 parts by weight of lithium oxide (Li₂O) due to oxidation by heat treatment.

### (Production of Cathode)

The cathode active material prepared above, Super-P as a conductive material, and PVdF as a binder were mixed at a weight ratio of 96.5:1.5:2 in the presence of N-methylpyrrolidone as a solvent to prepare a cathode active material paste. The cathode active material paste was applied onto an aluminum current collector, dried at 120° C., and then rolled to produce a cathode.

### (Production of Lithium Secondary Battery)

A porous polyethylene film as a separator was interposed between the cathode produced above and a Li metal as an anode to produce an electrode assembly, the electrode assembly was placed in a battery case, and an electrolyte was injected into the battery case to produce a lithium secondary battery. The electrolyte used herein was prepared by dissolving 1.0M lithium hexafluorophosphate (LiPF₆) in an organic solvent containing vinylene carbonate (VC: 2 wt %), in addition to ethylene carbonate/dimethyl carbonate/diethyl carbonate (mixed at a volume ratio of EC/DMC/DEC=1/2/1).

### Example 2

A cathode active material, a cathode, and a lithium secondary battery were produced under the same conditions as in Example 1, except that the heat treatment temperature was 250° C.

### Example 3

A cathode active material, a cathode, and a lithium secondary battery were produced under the same conditions as in Example 1, except that the heat treatment temperature was 350° C.

### Comparative Example 1

A cathode active material, a cathode, and a lithium secondary battery were produced under the same conditions as in Example 1, except that heat-treatment was performed without mixing with H₃BO₃.

### Comparative Example 2

A cathode active material, a cathode, and a lithium secondary battery were produced under the same conditions as in Example 1, except that the heat treatment temperature was 400° C.

### Comparative Example 3

A cathode active material, a cathode, and a lithium secondary battery were produced under the same conditions as in Example 1, except that the heat treatment temperature was 500° C.

### Comparative Example 4

A cathode active material, a cathode, and a lithium secondary battery were produced under the same conditions as in Example 1, except that the heat treatment temperature was 150° C.

TABLE 1

| | | | Heat treatment |
|---|---|---|---|
| | Core composition | H₃BO₃ | temperature |
| | Ni:Co:Mn: | (parts by weight) | (° C.) |
| Example 1 | 82:11:7 | 0.46 | 300 |
| Example 2 | 82:11:7 | 0.46 | 250 |
| Example 3 | 82:11:7 | 0.46 | 350 |
| Comparative | 82:11:7 | — | — |
| Example 1 | | | |
| Comparative | 82:11:7 | 0.46 | 400 |
| Example 2 | | | |
| Comparative | 82:11:7 | 0.46 | 500 |
| Example 3 | | | |
| Comparative | 82:11:7 | 0.46 | 150 |
| Example 4 | | | |

### Experimental Example 1

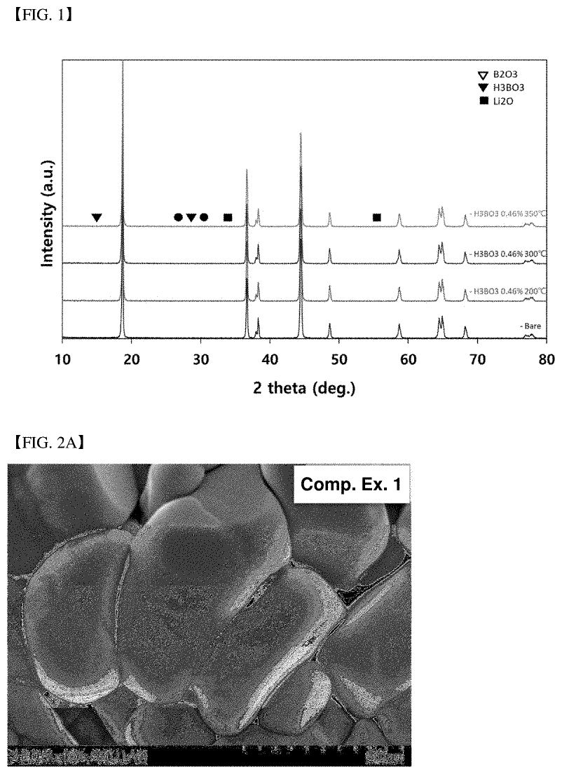

In order to identify the presence of crystalline phases of lithium oxide and boron oxide contained in the cathode active material according to an embodiment of the present invention, XRD diffraction of the cathode active materials prepared in Examples 1 and 2 was measured using Cu (Kα ray) and the results are shown in FIG. 1.

The XRD diffraction measurement conditions are as follows.
Target: Cu (Kα ray) graphite monochromator
Slit: divergence slit=1 degree, receiving slit=0.1 mm, scatter slit=1 degree
Measuring zone and step angle/measuring time: 10.0 degrees<2θ<80 degrees, 2 degrees/1 minute (=0.1 degrees/3 seconds), where 2θ (theta) represents the diffraction angle.

As can be seen from FIG. 1, in the XRD diffraction measurement results, the cathode active materials of Examples 1 and 2 did not show peaks at 2θ of near 33.646° and 56.407° corresponding to crystalline Li₂O, peaks at 2θ of near 32.05° and 26.003° corresponding to crystalline B₂O₃, and peaks at 2θ of near 28.051° and 14.971° corresponding to crystalline H₃BO₃.

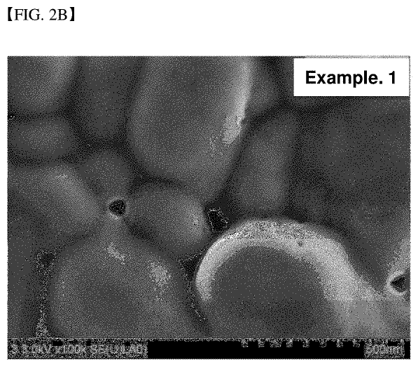

In addition, as can be seen from FIGS. 2A and 2B together, compared to the cathode active material of Comparative Example 1 (FIG. 2A), the cathode active material of Example 1 (FIG. 2B) is uniformly coated in an amorphous form without crystalline grain growth on the surface of the active material.

Accordingly, in the cathode active material according to an embodiment of the present invention, it may be determined that the coating layer is formed of Li₂O and B₂O₃ in an amorphous phase, rather than a crystalline phase.

### Experimental Example 2

Each of the lithium secondary batteries produced in Examples 1 to 4 and Comparative Examples 1 to 5 was subjected to 0.1C charge and 0.1C discharge twice at room temperature (25° C.) wherein charging was performed at 4.3V and the discharge cutoff voltage was 2.5V. The results are shown in the following Table 2.

TABLE 2

| | Formation 0.1 C/0.1 C (4.3-2.5 V, 25° C.) | | |
|---|---|---|---|
| Item | CC | DC | Eff (%) |
| Example 1 | 228.3 | 206.8 | 90.6 |
| Example 2 | 228.0 | 205.7 | 90.2 |
| Example 3 | 228.0 | 205.1 | 90.0 |
| Comparative | 225.0 | 202.3 | 89.9 |
| Example 1 | | | |
| Comparative | 225.8 | 203.9 | 90.3 |
| Example 2 | | | |
| Comparative | 225.2 | 202.9 | 90.1 |
| Example 3 | | | |
| Comparative | 224.9 | 201.2 | 89.5 |
| Example 4 | | | |

Then, the lithium secondary batteries were repeatedly subjected to 0.5C charge and 1.0C discharge wherein charging was performed at 4.3V and at 45° C. and the discharge cutoff voltage was 3.0V for evaluation of high-temperature lifespan characteristics. The discharge capacities at the 10^{th}, 20^{th} and 30^{th} cycles compared to the discharge capacity at the 1^{st} cycle are shown in Table 3 below.

TABLE 3

| | Cycle 0.5 C/1.0 C (4.3-3.0 V, 45° C.) | | | | | | | |
|---|---|---|---|---|---|---|---|---|
| | Cycle capacity (mAh/g) | | | | Cycle retention (%) | | | DCIR (%) |
| Item | 1CY | 10CY | 20CY | 30CY | 10CY/1CY | 20CY/1CY | 30CY/1CY | 30CY/1CY |
| Example 1 | 218.0 | 216.8 | 215.2 | 212.6 | 99.4 | 98.7 | 97.5 | 37.7% |
| Example 2 | 217.4 | 215.7 | 213.6 | 211.2 | 99.2 | 98.3 | 97.1 | 41.9% |
| Example 3 | 217.0 | 215.1 | 213.2 | 210.9 | 99.1 | 98.2 | 97.2 | 39.7% |
| Comparative | 213.4 | 210.6 | 207.8 | 205.0 | 98.7 | 97.4 | 96.1 | 114.0% |
| Example 1 | | | | | | | | |
| Comparative | 215.6 | 214.3 | 210.9 | 208.6 | 99.4 | 97.8 | 96.8 | 66.9% |
| Example 2 | | | | | | | | |
| Comparative | 214.8 | 212.8 | 209.2 | 206.9 | 99.1 | 97.4 | 96.3 | 96.9% |
| Example 3 | | | | | | | | |
| Comparative | 211.6 | 207.4 | 205.1 | 202.6 | 98.0 | 96.9 | 95.7 | 127.2% |
| Example 4 | | | | | | | | |

As can be seen from Tables 2 and 3, the lithium secondary batteries of Examples 1, 2, and 3 according to the present invention have high charge capacity and high discharge efficiency and exhibit remarkably excellent cycle characteristics at high temperatures, in particular, excellent resistance characteristics based on the reduction in the increase rate of direct current internal resistance (DCIR) related to the lifespan of the secondary battery.

The reason for this is that, in active materials of Examples according to the present invention, as the heat treatment for forming the coating layer is performed at a relatively low temperature, lithium oxide and boron oxide contained in the coating layer are uniformly formed in an amorphous phase on the surface of the active material and thus prevent side reactions with the electrolyte, facilitate the movement of lithium ions and improve electrical conductivity (lithium ion conductor).

In Comparative Example 2, the firing temperature was relatively high and thus there was no great influence on the increase in the charging capacity and the high-temperature lifespan compared to Comparative Example 1, but the discharge efficiency slightly increased due to the formation of an amorphous coating layer to some extent, and the lifespan and lifespan resistance characteristics were slightly improved.

Comparative Example 3 exhibited poor properties compared to Examples of the present invention although the coating layer contains boron oxide like Examples of the present invention. The reason for this is that, as the heat treatment to form the coating layer was performed at a relatively high temperature, a crystalline coating layer was formed on the surface of the core.

Comparative Example 4 exhibited poor properties compared to Examples of the present invention although the coating layer contains boron oxide like Examples of the present invention. The reason for this is that, as the heat treatment to form the coating layer was performed at a relatively low temperature, the melting point of H₃BO₃ was not reached and a coating layer was not formed uniformly on the surface of the core active material.

Although preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cathode active material for a lithium secondary battery comprising:
a core containing lithium composite metal oxide; and
a coating layer disposed on the core, the coating layer including an amorphous phase,
wherein the amorphous phase contains lithium oxide and boron oxide in a form of mixture.

2. The cathode active material according to claim 1, wherein the coating layer comprises a composition of the following Formula 2:
αBₓO_{y}−βLi₂O (2)
wherein the conditions of α+β=1 and 0.35≤x/y≤0.75 are satisfied.

3. The cathode active material according to claim 2, wherein the coating layer comprises a composition of the following Formula 3:
αB₂O₃−βLi₂O (3)
wherein the condition of α+β=1 is satisfied.

4. The cathode active material according to claim 1, wherein, in X-ray diffractometry, no peak is observed in the vicinity of any one of 2θ=32.05°, 26.003°, 28.051°, 14.971°, 33.646°, and 56.407°.

5. The cathode active material according to claim 4, wherein the X-ray diffractometry is performed under the following XRD diffraction measurement conditions:
Target: Cu (Kα ray) graphite monochromator
Slit: divergence slit=1 degree, receiving slit=0.1 mm, scatter slit=1 degree
Measuring zone and step angle/measuring time: 10.0 degrees<2θ<80 degrees, 2 degrees/1 minute (=0.1 degrees/3 seconds), where 2θ (theta) represents a diffraction angle.

6. The cathode active material according to claim 1, wherein the core has an average particle diameter of 1 to 50 μm.

7. The cathode active material according to claim 1, wherein the lithium oxide is present in an amorphous phase in an amount of 0.01 to 2 parts by weight and the boron oxide is present in an amorphous phase in an amount of 0.01 to 2 parts by weight based on 100 parts by weight of the core.

8. The cathode active material according to claim 1, wherein the amorphous phase comprises only the lithium oxide and the boron oxide in the form of mixture.

9. The cathode active material according to claim 1, wherein the coating layer has a thickness of 0.01 to 1 μm.

10. The cathode active material according to claim 1, wherein the coating layer is coated on 40 to 100% of a surface area of the core.

11. A method of preparing the cathode active material according to claim 1, the method comprising:
mixing (i) a boron-containing powder, or (ii) a boron-containing powder and a lithium-containing powder, with a lithium composite metal oxide powder for a core, followed by firing in an atmosphere containing oxygen in a temperature range within which an amorphous coating layer is formed.

12. The method according to claim 11, wherein the method comprises mixing the boron-containing powder with the lithium composite metal oxide powder, followed by firing, and the lithium oxide of the amorphous coating layer is derived from a lithium-containing component present on the surface of the lithium composite metal oxide powder.

13. The method according to claim 11, wherein the temperature range is 250 to 350° C.

14. A lithium secondary battery comprising the cathode active material according to claim 1.
